(19) United States
(12) Patent Application Publication
(10) Pub. No.: US 2003/0131255 A1
(43) Pub. Date: Jul. 10, 2003

(54) Secure data storage systems

(76) Inventor: Youngtack Shim, Cupertino, CA (US)

Correspondence Address: Youngtack Shim, 19500 Pruneridge Avenue, Apt. No. 10206, Cupertino, CA, 95014, US

(21) Appl. No.: 10/044,229

(22) Filed: Jan. 10, 2002

(51) Int. Cl. G06F 12/14

(52) U.S. Cl. 713/200

(57) ABSTRACT

The present invention relates to various data storage systems and methods therefor capable of allowing an authorized user to process various data stored therein and for preventing an unauthorized user from accessing such data. Such a data storage system may include at least one storage member, at least one process member, and at least one guard member. The storage member may be arranged to store the data therein and the process member may operationally be coupled to the storage member and arranged to process the data stored in the storage member. The guard member may operationally be coupled to the storage member and arranged to effect degradation of at least a portion of such data stored in the storage member and/or degradation of at least a portion of such a storage member itself. As will be described below, various guard members of this invention may effect such degradations in many different ways, e.g., magnetically, optically, chemically, mechanically, and the like. Therefore, the data storage systems and methods therefor of the present invention can provide secure means and methods for protecting data from being accessed by unauthorized users.

### FIELD OF THE INVENTION

The present invention relates to various data storage systems and methods therefor capable of allowing an authorized user to process various data stored therein and for preventing an unauthorized user from accessing such data. Such a data storage system may include at least one storage member, at least one process member, and at least one guard member. The storage member may be arranged to store the data therein and the process member may operationally be coupled to the storage member and arranged to process the data stored in the storage member. The guard member may operationally be coupled to the storage member and arranged to effect degradation of at least a portion of such data stored in the storage member and/or degradation of at least a portion of such a storage member itself. As will be described below, various guard members of this invention may effect such degradations in many different ways, e.g., magnetically, optically, chemically, mechanically, and the like. Therefore, the data storage systems and methods therefor of the present invention can provide secure means and methods for protecting data from being accessed by unauthorized users.

### BACKROUND OF THE INVENTION

With the advent of semiconductor fabrication technologies, various data storage systems such as magnetic and/or optical hard disks are now available at relatively low prices. It is very certain that development and commercialization of nano-technologies should provide more compact data storage systems smaller in sizes but enormous in the amounts of data that can be stored therein. Even today, most computers are equipped with hard disks that can store various data in the ranges of giga and/or tera bytes.

Only a decade ago, a major pecuniary value of almost all computers has been resided in their hardwares, i.e., central processing units (commonly referred to as “CPU's”) and data storage systems such as magnetic hard disks, read-only memories (such as “ROM's”), and random-access memories (i.e., “RAM's”). A total amount of data stored in such data storage systems has amounted to several tens of megabytes, only a fraction of storage capacities of current data storage systems. Accordingly, most users were not able to cram all of their data into the hard disks of their own computers and were generally compelled to rely on various back-up data storage systems, e.g., storing their data in tens or hundreds of back-up floppy disks or installing external hard disks to the computers and storing extra data therein. When their computers were stolen or damaged, a major pecuniary damage to such users was to replace their hardwares. Upon acquiring new computers, the users could simply load the data stored in the back-up disks onto the hard disks of the computers.

To the contrary, today's computers are generally equipped with hard disks capable of storing an enormous amount of data. Most computer users are now accustomed to make the best use of such hard disks by storing a huge amount of personal and/or work-related data and by downloading huge files and folders from the internet. Therefore, it is now virtually impossible to keep a current backup library of hundreds or thousands of floppy disks. In order to accommodate such dramatic changes in hardware technology, high-capacity ZIP disks and recordable or rewritable compact disks become available in the market. If used properly, a loss of data resulting from the loss of computer can easily be remedied by dumping back the data into a newly acquired hardware.

Such a remedy is not amenable at all, however, if the data stored in the lost computer or hard disk driver is highly confidential in nature. In many cases, a pecuniary loss due to the lost hardware is negligible in its magnitude compared with the capital and/or intellectual property value of the lost data. Even if such confidential data may be restored from the back-up library system, the loss of the data cannot be remedied in case such data should end up in the wrong hand. The user can only wish he or she would have crushed the piece of hardware rather than delivering precious data to his or her competitors or mortal enemies.

Therefore, there is a need to provide various data storage systems, data storage devices, data processing systems, and methods therefor capable of preventing unauthorized users from accessing the data stored therein.

### SUMMARY OF THE INVENTION

The present invention relates to various data storage systems and methods therefor capable of allowing an authorized user to process various data stored therein and for preventing an unauthorized user from accessing such data.

In one aspect of the invention, a data storage system may include at least one storage member, at least one process member, and at least one guard member. The storage member may be arranged to store the data therein and the process member may operationally be coupled to the storage member and arranged to process the data stored in the storage member. The guard member may operationally be coupled to the storage member and arranged to effect degradation of at least a portion of such data stored in the storage member and/or degradation of at least a portion of such a storage member itself.

The data storage systems and methods therefor of the present invention described heretofore and hereinafter offer numerous benefits over their various prior art counterparts. First of all, the data storage systems and methods therefor of this invention may prevent access to the data stored therein by unauthorized users by degrading the data and/or the data storage systems themselves. Therefore, even when the unauthorized users succeed in negotiating with and in gaining access to the operation systems of the computers, they can only extract degraded data that are not generally in a retrievable format and that can not be reconstructed by any conventional decoding algorithms. Secondly, such data storage systems and methods therefor of this invention may not need data encryption algorithms per se for protection of the data. By obviating encryption and decoding processes, such systems and methods of this invention may allow faster processing of the data. Thirdly, the data storage systems and methods therefor of this invention can readily be applied to various data processing devices such as magnetic disk drivers and optical disk drivers as well as to individual data storage devices such as magnetic and/or optical floppy disks, compact disks, digital video disks, and the like. Therefore, the data storage systems and methods therefor of the present invention provide ways to protect not only the disk drivers but also the disks themselves from unauthorized attempts by unauthorized users.

Exemplary embodiments of the foregoing aspects of the present invention may include one or more of the following features.

The data stored in the storage member may be characters, alphabets, numbers, symbols, texts, voices, sounds, colors, images, and the like. Such data may be stored in various analog and/or digital formats.

The storage member may include at least one magnetic storage unit arranged to use magnetic characteristics to store the data, at least one optical storage unit arranged to use optical characteristics to store such data, at least one physicochemical storage unit arranged to employ physical or chemical characteristics of molecules to store such data, and functional equivalents thereof. The magnetic unit may include at least one magnetic disk, magnetic tape, and/or magnetically operating semiconductor memory chip. Similarly, the optical unit may include at least one optical disk, an optically operating semiconductor memory chip, and the like. Such a storage member may include at least one floppy disk, hard disk, compact disk, digital video disk, and functional equivalents thereof. Such disks may be read-only disks, recordable disks, and/or rewritable disks. The storage member may also include at least one random access memory, flash memory, and read-only memory.

The process member may include at least one of a magnetic head and an optical head, each of which may be arranged to perform processing of at least a portion of such data. The process member may be arranged to perform, e.g., reading the data from the storage member, writing the data into the storage member, and so on. It is generally preferred that a first amount of the data to be degraded by the guard member during a pre-determined period be larger than a second amount of such data to be processed by the process member during the same pre-determined period. The guard member may be generally arranged to not encrypt such data and to not perform the reading and writing of the data.

The data storage system of this invention may include at least one access member arranged to perform detection of an unauthorized attempt to access the data stored in the storage member by the unauthorized user. Such an unauthorized attempt may refer to, e.g., receiving an invalid login signal by the unauthorized user, movement of the storage member, uncoupling of the storage member from an article coupled thereto, disassembly of the storage member, and any other events that may lead to exposure of the data stored in the storage member to the unauthorized user. Receiving invalid login signals may include receiving such signals for a pre-determined number of times and receiving such signal for a pre-determined period. Such invalid login signals may be invalid passwords and/or may relate to at least one characteristics of such an unauthorized user examples of which may include, but not limited to, finger prints, voices, breadths, facial patterns, distribution patterns of blood vessels of the unauthorized user, and the like. The movement of the storage member may be with respect to the ground or other stationary objects thereon, process member, guard member, system itself, and so on. For this purpose, the access member may include a motion sensor arranged to detect the movement of the storage member. The uncoupling of the storage member may be electrical, optical, magnetic, and/or mechanical uncoupling from such an article, where the access member may include a sensor arranged to detect such uncoupling of the storage member from the article. The storage member may include at least one memory unit and a housing, where the memory unit may be arranged to store the data magnetically and/or optically, where the housing may be arranged to retain at least a substantial portion of the memory unit therein, and where the disassembly of the storage member may generally correspond to expose at least a portion of the memory unit from or out of such a housing. The access member may also include a sensor arranged to detect such disassembly of the storage member.

The guard member may be operationally coupled to the access member and arranged to effect such degradation upon or after the detection of such unauthorized attempts.

In one exemplary embodiment, the guard number may be arranged to generate magnetic field adjacent to or around at least a portion of the storage member to effect such degradation. The guard member may be provided with at least one power supply unit arranged to supply the guard member with electric power to generate such magnetic field. The portion of the storage member affected by the magnetic field may at least partially correspond to the portion of the storage member degraded by the guard member. The guard number may also include at least one electromagnetic unit arranged to generate such magnetic field upon or after the detection. The electromagnetic unit may include at least one head having at least one electromagnet arranged to be disposed adjacent to or over at least a portion of the storage member. The electromagnetic unit may include at least one electromagnetic coil arranged to wrap at least a portion of the storage member. Alternatively, the guard number may include at least one permanent magnetic unit and at least one actuator unit. The permanent magnetic unit may be arranged to generate the magnetic field and the actuator unit may be arranged to dispose such a permanent magnetic unit within a pre-selected distance from at least a portion of the storage member upon or after the detection and to dispose the permanent magnetic unit farther than the preselected distance from such a portion of the storage member before such detection. The permanent magnetic unit may also include at least one head having at least one permanent magnet arranged to cover at least a portion of the storage member. The permanent magnetic unit may further include at least one coil including at least one permanent magnet and wrapped around at least a portion of the storage member. Alternatively, the guard number may include at least one permanent magnetic unit, at least one shield unit, and at least one actuator unit. The permanent magnetic unit may be arranged to generate such magnetic field, while the shield unit may be arranged to shield at least a substantial portion of the magnetic field propagating therethrough. The actuator unit may be arranged to dispose the shield unit between the permanent magnetic unit and the storage member to prevent the magnetic field from affecting the portion of the storage member and to remove the shield unit therefrom upon or after the detection to effect such degradation. The permanent magnetic unit may also include at least one head including at least one permanent magnet arranged to cover or be disposed over at least a portion of the storage member. The permanent magnetic unit may further include at least one coil having at least one permanent magnet and wrapped around at least a portion of the storage member. Alternatively, the permanent magnetic unit may include multiple articles that may be ferromagnetic, ferrimagnetic, and paramagnetic. The shield unit may be arranged to retain such articles before the detection, while the actuator unit may be arranged to disperse the articles toward the storage member upon and after the detection.

At least a portion of the storage member may be arranged to translate or rotate with respect to the guard member during the degradation of the storage member and/or the data stored in the storage member. Alternatively, at least a portion of the guard member may be arranged to translate or rotate with respect to the storage member during such degradation of the storage member or the data stored in the storage member.

In another exemplary embodiment, the guard number may be arranged to irradiate amplified light rays to effect such degradation. The guard member may include at least one power supply unit arranged to supply the guard member with electric power to irradiate such amplified light rays. The portion of the storage member irradiated by the amplified light rays may at least partially correspond to the portion of the storage member degraded by the guard member.

The guard member may include at least one optical source arranged to irradiate the amplified light rays. The guard member may further include at least one optical element arranged to guide the amplified light rays. Examples of such optical elements may include, but not necessarily limited to, a mirror, a lens, a prism, and so on, while a typical example of the amplified light rays may be lasers. At least a portion of the storage member may be arranged to move, translate or rotate with respect to the guard member during the degradation of the storage member and/or the data stored in the storage member. At least a portion of the guard member may further be arranged to move, translate or rotate with respect to the storage member during the degradation of the storage member or the data stored in the storage member.

In another embodiment, the guard number may be arranged to contact at least a portion of the storage member with at least one chemical agent to effect the degradation. The portion of the storage member contacted by the chemical agent generally at least partially corresponds to the portion of the storage member degraded by the guard member. Such a chemical agent may be gas, liquid, solid or a mixture thereof. Such a chemical agent may generally cause, in the portion of the storage member, chemical changes including, e.g., oxidation thereof, reduction thereof, dissolution thereof, corrosion thereof, adhesion of the chemical agent thereonto, crystallization thereof, change in crystalline states or phases thereof, polymerization thereof, magnetization thereof, and so on. The chemical agent may also be arranged to etch out the portion of the storage member from the rest thereof. Such a portion of the storage member may be composed of any semiconductive elements such as silicon, aluminum, germanium, and zirconium and/or various semiconductive compounds including polymeric materials. Such semiconductive compounds may also be doped by p-type and/or n-type dopants. The chemical agent may be or may include at least one compound including fluorine, bromine, chlorine, and other corrosive elements or compounds.

The guard number may include at least one chamber and at least one actuator unit, where the chamber may be arranged to store such a chemical agent before the detection and where the actuator unit may be arranged to move various chemical agents out of the chamber toward the portion of the storage member upon or after the detection. The guard number may include at least one conduit unit arranged to guide the chemical agent toward at least one pre-selected location on, over or inside the storage member. Alternatively, the guard number may include at least one applicator unit arranged to not include at least a substantial amount of the chemical agent before such detection and to receive the chemical agent from the chamber and apply the chemical agent toward the portion of the storage member upon or after such detection. The guard number may include at least one another applicator unit and at least one cover unit which is operationally coupled to the applicator unit and arranged to move between a first position and a second position. The applicator unit may be arranged to include the chemical agent therein, while the cover unit may be arranged to be disposed in the first position before the detection and arranged to prevent the chemical agent contained in the applicator unit from contacting the portion of the storage member. The cover unit may then be arranged to be disposed in the second position upon or after the detection, where it may be arranged to make the chemical agent in the applicator unit contact the portion of the storage member. At least a portion of such a storage member may be arranged to move, translate, and/or rotate with respect to the guard member during the degradation of the storage member or the data stored in the storage member. At least a portion of the guard member may also be arranged to move, translate, and/or rotate with respect to the storage member during the degradation of the storage member and/or the data stored in the storage member.

In yet another embodiment, the guard number may alternatively be arranged to mechanically damage at least a portion of the storage member to effect such degradation. The guard member may also include at least one power supply unit arranged to supply the guard member with electric and/or mechanical power to cause mechanical damage on the portion of the storage member. The portion of the storage member mechanically damaged by the guard member may at least partially correspond to the portion of the storage member to be degraded by such a guard member. The guard number may be arranged to cause deformation of at least the portion of the storage member while maintaining the integrity of the storage member. Such a guard member may include at least one applicator unit that may be arranged to push, pull, bend, and/or compress such a portion of the storage unit to effect such deformation. The guard member may also be arranged to cause disintegration or breakage of at least the portion of the storage member into more than two segments. The guard member may include at least one applicator unit arranged to disintegrate the portion of the storage member by, e.g., pushing, pulling, twisting, bending, and/or punching out the portion of the storage member. To facilitate such disintegration, the storage member may be provided with at least one impression such as a protrusion and a depression along which the guard member may cause the disintegration of such a portion of the storage member. Such an impression may be linear, curved, circular, and/or elliptical, and may also be two- and/or three-dimensional depending upon preferred patterns of the disintegration. The guard member may also be arranged to grind, scrape or sand off at least the portion of the storage member from a rest of the storage member. Such a storage member may include a surface portion arranged to store the data therein and a core portion arranged to support the surface portion, where the portion of such a storage member ground, scraped or sanded off by such a guard number may at least partially correspond to the portion of the storage member degraded by the guard member. At least a portion of the storage member may further be arranged to move, translate, and/or rotate with respect to the guard member during the degradation of the storage member and/or during that of the data stored in the storage member. In the alternative, at least a portion of the guard member may also be arranged to move, translate, and/or rotate with respect to the storage member during the degradation of such a storage member and/or such data stored in the storage member.

The foregoing data storage system may be operationally incorporated into various electronic and electric devices examples of which may include, but not limited to, various computers, database equipment, communication equipment, audio equipment, and video equipment.

In another aspect of the invention, a magnetic data storage system may be provided to allow an authorized user to process data stored therein and to prevent an unauthorized user from accessing such data. A typical magnetic data storage system may include at least one storage member, at least one process member, and at least one guard member. The storage member may be arranged to store the data therein magnetically or using magnetic characteristics thereof. The process member may be operationally coupled to the storage member and arranged to magnetically process the data stored in the storage member. The guard member may also be operationally coupled to the storage member and arranged to generate magnetic field around at least a portion of the storage member and to effect degradation of the portion of the storage member and/or degradation of at least a portion of the data stored in the portion of the storage member. Exemplary embodiments of this aspect of this invention are at least substantially similar to or identical to the foregoing embodiments of foregoing aspects of the present invention.

In yet another aspect of the invention, another data storage system may be provided to allow an authorized user to process data stored therein and to prevent an unauthorized user from accessing such data. Such a data storage system may include at least one storage member, at least one process member, and at least one guard member. The storage member may also be arranged to store the data therein magnetically or optically. The process member may be operationally coupled to the storage member and arranged to process such data magnetically and/or optically. The guard member may be operationally coupled to the storage member and arranged to contact a chemical agent with at least a portion of the storage member and to effect degradation of the portion of the storage member and/or to effect degradation of at least a portion of such data stored in the portion of the storage member. In the alternative, the guard member may be arranged to inflict mechanical damage on at least a portion of the storage member to effect degradation of such a portion of the storage member and/or that of at least a portion of such data stored in the portion of the storage member. Exemplary embodiments of this aspect of this invention may also be at least substantially similar to or identical to the foregoing embodiments of foregoing aspects of the present invention.

In a further aspect of the invention, another data storage system may be provided to allow an authorized user to process data stored therein and to prevent an unauthorized user from accessing the data. Such a system may typically include at least one storage member, at least one access member, and at least one guard member. Such a storage member may be arranged to store the data, while the access member may be arranged to perform detection of an unauthorized attempt to access the data by the unauthorized user. The guard member may be operationally coupled to the storage member and arranged to effect degradation of at least a portion of the storage member and/or degradation of at least a portion of the data stored therein upon or after a pre-selected period of the detection of such unauthorized attempt. Exemplary embodiments of this aspect of this invention may also be at least substantially similar to or identical to the foregoing embodiments of foregoing aspects of the present invention.

In another aspect of the invention, a magnetic data storage system may be provided to allow an authorized user to process data stored therein and to prevent an unauthorized user from accessing such data. Such a system may include at least one storage member that is arranged to magnetically store the data therein, at least one process member operationally coupled to the storage member and arranged to magnetically process the data stored in the storage member, as well as at least one guard member operationally coupled to the storage member and arranged to generate magnetic field around at least a portion of the storage member and to effect at least one of degradation of the portion of the storage member and degradation of at least a portion of the data stored in the portion of the storage member. Exemplary embodiments of this aspect of this invention may also be at least substantially similar to or identical to the foregoing embodiments of foregoing aspects of the present invention.

In yet another aspect of the invention, a data storage system may be provided for allowing an authorized user to process data stored therein and for preventing an unauthorized user from accessing such data. The typical data storage system includes at least one storage member arranged to store the data therein magnetically and/or optically, at least one process member operationally coupled to the storage member and arranged to process the data stored in the storage member magnetically and/or optically, and at least one guard member operationally coupled to the storage member and arranged to contact a chemical agent with at least a portion of the storage member and to effect degradation of the portion of the storage member and/or degradation of at least a portion of such data stored in the portion of the storage member. Exemplary embodiments of this aspect of this invention may also be at least substantially similar to or identical to the foregoing embodiments of foregoing aspects of the present invention.

In a further aspect of this invention, a data storage system may also be provided to allow an authorized user to process data stored therein and to prevent an unauthorized user from accessing the data. Such a data storage system may include at least one storage member arranged to store said data therein magnetically and/or optically, at least one process member which is operationally coupled to the storage member and arranged to process the data stored in the storage member magnetically or optically, and at least one guard member operationally coupled to the storage member and arranged to inflict mechanical damage on at least a portion of the storage member and to effect degradation of the portion of the storage member and/or degradation of at least a portion of such data stored in the portion of the storage member. Exemplary embodiments of this aspect of this invention may also be at least substantially similar to or identical to the foregoing embodiments of foregoing aspects of the present invention.

In yet another aspect of the invention, a data storage system may be provided for allowing an authorized user to process data stored therein and for preventing an unauthorized user from accessing such data. An exemplary system may include at least one storage member arranged to store the data therein, at least one access member that is arranged to perform detection of an unauthorized attempt to access such data by the unauthorized user, and at least one guard member operationally coupled to the storage member and arranged to effect degradation of at least a portion of the storage member and/or degradation of at least a portion of the data stored therein upon and after a pre-selected period of such detection of such unauthorized attempt.

In another aspect of the present invention, a computer may be provided to protect data stored therein from an unauthorized user through an unauthorized attempt to access such data and to allow the data to be processed by an authorized user through an authorized access. Such a computer may include at least one storage member arranged to store the data therein, at least one process member operationally coupled to the storage member and arranged to process such data stored in the storage member, at least one access member arranged to perform detection of such unauthorized attempt by the unauthorized user, and at least one guard member operationally coupled to the storage member and arranged to effect degradation of at least a portion of the storage member and/or degradation of at least a portion of such data stored therein upon and after a pre-selected period of such detection of the unauthorized attempt.

In yet another aspect of the invention, a data process system may be provided to receiving at least one data storage device, to allow an authorized user to store to such a data storage device and to access data stored therein, and to prevent an unauthorized user from accessing such data. The system may include at least one receiver member arranged to receive the data storage device therein, at least one process member operationally coupled to the receiver member and arranged to process the data stored in the storage device received by the receiver member, and at least one guard member that is operationally coupled to the receiver member and arranged to effect degradation of at least a portion of the data storage device and/or degradation of at least a portion of the data that is stored in the data storage device. Exemplary embodiments of this aspect of this invention may be at least substantially similar to or identical to the foregoing embodiments of foregoing aspects of the present invention.

In a further aspect of the present invention, a data storage device may be provided to allow an authorized user to process data stored therein and to prevent an unauthorized user from accessing the data. The data storage device may include at least one storage unit arranged to store the data therein, at least one guard unit operationally coupled to the storage unit and arranged to effect degradation of at least a portion of the storage unit and/or degradation of at least a portion of such data stored in the storage unit, at least one power supply unit arranged to supply the guard member with power enough to effect such degradation, and a housing arranged to retain at least a portion of the guard unit, power supply unit, and storage unit. Exemplary embodiments of this aspect of this invention may also be at least substantially similar to or identical to the foregoing embodiments of the foregoing aspects of the present invention.

The data storage systems and methods therefor of this invention described heretofore as well as hereinafter can be used to serve many different purposes. First, such systems and methods can be used as hard disks, disk drivers, RAMs, and ROMs for desk-top and lap-top computers. In addition, such systems and methods may be incorporated into floppy disks, compact disks, and/or digital video disks that can be processed by the foregoing drivers. Furthermore, such systems and methods may be applied as memory units in various electric, electronic, optoelectric, and/or optoelectronic devices examples of which may include, but not necessarily limited to, electronic data bases, communication equipment, audio equipment, and video equipment.

In another aspect, a method may be provided to allow an authorized access by an authorized user to data stored in a storage member and/or a storage device of various data storage systems and to prevent an unauthorized access by an unauthorized user to such data. Such a method may include the exemplary steps of detecting an unauthorized attempt to access the data by the unauthorized user and degrading at least a portion of such data before the unauthorized user accesses such data.

Exemplary embodiments of the foregoing aspects of the present invention may include one or more of the following features.

The detecting step may include at least one of the steps of receiving an invalid login signal by the unauthorized user, sensing unauthorized movement of the storage member, sensing uncoupling of the storage member from an article coupled thereto, and sensing disassembly of the storage member. The receiving step may include at least one of the steps of receiving the invalid login signal for a predetermined number of times and receiving such an invalid login signal for a pre-determined period. The step of sensing the movement may include the step of sensing such a movement of the storage member with respect to a stationary object. The step of sensing the uncoupling may include the step of sensing electrical, optical, and/or mechanical uncoupling between the storage member and article. Where the storage member may include at least one memory unit arranged to store the data as well as an outer housing arranged to retain at least a portion of the memory unit therein, the step of sensing the disassembly may include the steps of operationally coupling at least one sensor to such a memory unit of the storage member and sensing disposition of the memory unit out of the housing.

The degrading step may not necessarily include any of the steps of encrypting or decrypting at least a portion of such data. In addition, the degrading step may be performed upon or after a preselected period of the detecting step. The foregoing method may also include the step of providing at least one power supply unit capable of supplying the storage member with power enough to perform the foregoing degrading step. The degrading step may also include the steps of moving, translating, and/or rotating the storage member during the degrading step.

The degrading step may further include at least one of the steps of magnetically degrading the foregoing portion of the foregoing data, optically degrading such a portion of such data, chemically degrading the portion of the data, and mechanically degrading the portion of the data.

The magnetically degrading step may include the step of generating magnetic field around at least a portion of the storage member. The generating step may then include at least one of the steps of disposing an electromagnet proximal to, adjacent to, over, and/or around the portion of the storage member and placing a permanent magnet proximal to, adjacent to, over, and/or around the portion of the storage member. The disposing step may include the steps of deactivating such an electromagnet before the detecting step and activating such an electromagnet upon or after the detecting step. The placing step may include the steps of positioning the permanent magnet out of a pre-selected distance from at least a portion of the storage member before the detecting step and displacing the permanent magnet within the pre-selected distance from or proximate to the portion of the storage member upon or after the detecting step. The placing step may alternatively include the steps of positioning at least one shield between the permanent magnet and the portion of the storage member to prevent at least a substantial portion of the magnetic field from propagating toward the portion of the storage member before the detecting step, and removing the shield therefrom upon or after the detecting step in order to allow the magnetic field to propagate to the portion of the storage member. The placing step may also include the steps of storing multiple articles of the permanent magnet in a magnetically shielded container before the detecting step and dispersing the permanent magnetic articles onto the portion of the storage member upon or after the detecting step.

The chemically degrading step may include the step of mechanically or chemically contacting at least a portion of the storage member with at least one chemical agent. This embodiment may also include at least one of the steps of oxidizing the portion of the storage member by the chemical agent, reducing the portion of the storage member thereby, dissolving such a portion of the storage member thereby, corroding such a portion of the storage member thereby, etching the portion of the storage member thereby, adhering such a chemical agent to the portion of the storage member, crystallizing the portion of the storage member by the chemical agent, changing a crystalline phase of the portion of the storage member thereby, polymerizing the portion of the storage member thereby, magnetizing the portion of the storage member thereby, and the like. The contacting step may include the steps of storing such chemical agents in a chamber disposed away from at least another portion of the storage member before said detecting step and applying such chemical agents out of the chamber over, on or adjacent the portion of the storage member upon or after the detecting step. The applying step may include the steps of dispensing the chemical agent out of the chamber and then spraying, dispensing, dropping or smearing such a chemical agent onto the portion of the storage member. The contacting step may include the steps of storing the chemical agent in an applicator unit that is not in a chemical contact with the portion of the storage member before the detecting step and then spraying, dropping, dispensing or smearing the chemical agent onto the portion of the storage member upon or after the detection. The method may also include the steps of disposing the applicator unit proximate to such a portion of the storage member and providing a cover therebetween during the storing step and then removing the cover therefrom before the dispensing step. The method may also include the steps of disposing the applicator unit at a pre-determined distance from the portion of such a storage member during the storing step and displacing the applicator unit within the predetermined distance from, on or over the portion of the storage member before the dispensing step.

The mechanically degrading step may include the step of damaging at least a portion of such a storage member mechanically. The foregoing damaging step may include at least one of the steps of deforming at least such a portion of the storage member while maintaining mechanical integrity of the storage member, disintegrating at least the portion of the storage member into multiple segments, and grinding off at least the portion of the storage member. The method may also include the step of providing at least one impression at least on such a portion of the storage member along which such a portion of the storage member may be damaged mechanically.

As used herein, the term “process” generally refers to read, write, store, arrange, manipulate or retrieve data. Similarly, the phrase “processed data” generally means the data that were processed, are currently being processed, and/or will be processed.

“Data” generally mean any intangible substances in the context of any information related to, e.g., computer source and object codes; information in the fields of technology, science, and finance; audiovisual information including, but not limited to, sounds and images; and the like. “Data” also include such information in various formats, e.g., an ASCII code, binary code, and other formats that are conventionally used in digital computers, microchips, and/or their functional equivalents.

An “unauthorized attempt” to access data generally means any attempts by any unauthorized users to gain access to a computer, a data storage system thereof such as a hard disk (i.e., a hard disk unit or a hard disk drive), a data storage device thereof such as a floppy disk, a compact disk, a ZIP disk, and a digital video disk, various data stored therein, and so on. Examples of such unauthorized attempts may include, but not necessarily limited to, supplying an invalid login signals; displacing or moving the computer, data storage system, and/or data storage device without proper authorization; uncoupling the computer from a network, uncoupling such a data storage system from the computer or uncoupling such a data storage device from the data storage system without proper authorization; breaking, disassembling or disintegrating the computer, the disk storage system, and the disk storage device without proper authorization; hacking into the operating system of the computer without any authorization; and the like. It is appreciated that the criteria for the unauthorized attempt may vary depending upon individual circumstances. Accordingly, such criteria and logic for detecting such may be tailored by the operator and may differ from one case to the others.

Unless otherwise defined in this specification, all technical and scientific terms used herein have the same meaning as commonly understood or used by one of ordinary skill in the art to which this invention belongs. Although various methods and/or materials equivalent to or similar to those described herein can also be used in the practice or testing of the present invention, suitable methods and/or materials are described below. All published patent applications, patents, publications, and/or other references mentioned herein are incorporated by reference in their entirety. In case of conflict, the present specification, including definitions, will control. In addition, unless other specified, the materials, methods, and/or examples herein are exemplary and illustrative only, and not intended to be limiting.

Other features and advantages of the present invention will become apparent from following detailed description and from the claims.

### BRIEF DESCRIPTION OF THE DRAWINGS

FIG. 1 is a schematic diagram of an exemplary data storage system according to the present invention;

FIG. 2 is a schematic diagram of an exemplary embodiment of an access member of the data storage system according to the present invention;

FIG. 3 is a schematic diagram of another exemplary data storage system having a different configuration according to the present invention;

FIG. 4 is a schematic diagram of an exemplary embodiment of a guard member of the data storage system according to the present invention;

FIG. 5 is a perspective view of a prior art hard disk unit according to the present invention;

FIG. 6 is a perspective view of another exemplary embodiment of a guard member of the data storage system effecting magnetic degradation according to the present invention;

FIG. 7 is a perspective view of yet another exemplary embodiment of a guard member of the data storage system effecting another magnetic degradation according to the present invention;

FIG. 8 is a perspective view of yet another exemplary embodiment of a guard member of the data storage system effecting chemical degradation according to the present invention; and

FIG. 9 is a perspective view of yet another exemplary embodiment of a guard member of the data storage system effecting mechanical degradation according to the present invention.

### DETAILED DESCRIPTION OF EXEMPLARY EMBODIMENTS

The present invention relates to various data storage systems and methods therefor capable of allowing an authorized user to process various data stored therein and for preventing an unauthorized user from accessing and processing the data. Following two steps are generally required to fulfill the foregoing objectives of this invention, i.e., detecting unauthorized attempts by the unauthorized user to access such data and degrading at least a portion of the data before the unauthorized user accesses and/or processes the data. Such data storage systems and methods therefor may be readily applied to various data storage devices such as, e.g., hard disks, RAMs, ROMs, and disk drivers for personal as well as main-frame computers and may also be incorporated into floppy disks, compact disks, digital video disks, and/or ZIP disks which can be processed by the foregoing drivers. FIGS. 1 to 7 describe various exemplary embodiments of the data storage systems, their constituents, and methods therefor according to the invention. It is noted, however, that the exemplary embodiments of the systems and methods described herein are only illustrative and not intended to limit the scope of this invention.

FIG. 1 is a schematic diagram of an exemplary data storage system according to the present invention, where such a data storage system 200 may be incorporated into a computer 100 and used as a hard disk thereof. For ease of illustration, computer 100 in FIG. 1 is simplified as comprising at least one central processing unit (i.e., the “CPU”) 110, at least one input-output unit 130, and at least one data storage system 200 which may in turn include at least one storage member 210, at least one process member 230, at least one access member 300, and at least one guard member 400. Storage member 210 of data storage system 200 may be generally arranged to magnetically or optically store various data therein. Process member 230 of data storage system 200 may be arranged to process the data stored in storage member 210, i.e., reading data therefrom and writing data thereonto, as well as to perform other tasks such as, e.g., rearranging such data, formatting storage member 210, and so on. The CPU 110 may run various application programs and/or process such data based on, e.g., external commands received through input-output unit 130. Access member 300 of data storage system 200 may be arranged to receive various login signals such as log-in commands through input-output unit 130 and to assess whether such login signals are “valid login signals” entered by authorized users or whether such login signals are “invalid login signals” entered by unauthorized users. Guard member 400 may be operationally coupled to storage member 210 and arranged to degrade at least a portion of the data stored in storage member 210.

In operation, data storage system 200 of FIG. 1 may be arranged to prevent the unauthorized user from accessing the data stored in storage member 210 of data storage system 200. For example, an user may enter an login signal through input-output unit 130. Access member 300 receives such a login signal and assesses authenticity thereof. When such a login signal is verified as the valid login signal entered by the authorized user, access member 300 grants the user the access to the data stored in storage member 210. Upon assessing unauthorized attempts to assess the data by the unauthorized user, however, access member 300 alerts guard member 400 which then operates to degrade at least a portion of the data stored in storage member 210.

Foregoing data storage systems 200 and various members thereof may be realized by various embodiments. For example, storage member 210 may be generally arranged to store data which may be characters, numbers, symbols, texts, voices, sounds, colors, images, and the like. Storage member 210 may be arranged to store such data in any arbitrary format, although various digital formats may be preferred. Storage member 210 may include at least one magnetic unit arranged to use magnetism or magnetic characteristics of at least a portion of storage member 210 to store the data therein or at least one optical unit arranged to use optics or optical characteristics thereof to store the data therein. The magnetic unit may include one or more magnetic disks, magnetic tapes, magnetically operating semiconductor memory chips, and so on, while the optical unit may include at least one optical disk, optically operating semiconductor memory chip, and the like. Storage member 210 may also include at least one floppy disk, hard disk, compact disk, and/or digital video disk, where such a disk may be a read-only disk, a recordable disk, and/or a rewritable disk. Examples of such a storage member 210 may include a random access memory, a flash memory, and a read-only memory.

Process member 230 may include at least one magnetic head and/or at least one optical head, each of which may process at least a portion of any of the foregoing data. Process member 230 may be arranged to perform reading such data from storage member 210 and/or writing or recording such data into storage member 210.

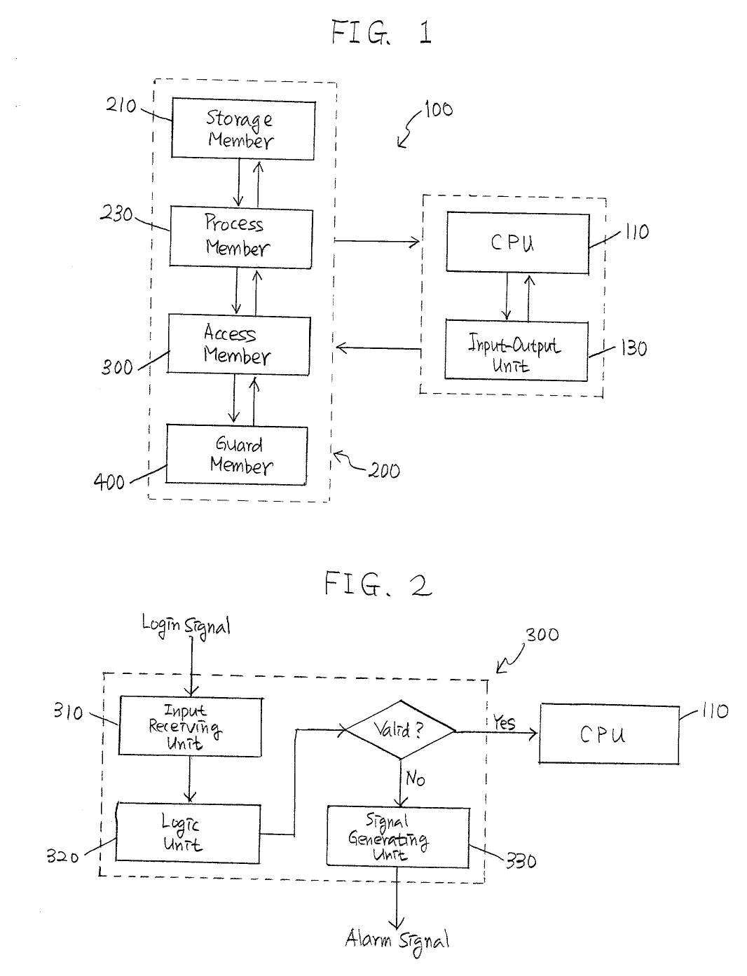

FIG. 2 is a schematic diagram of an exemplary embodiment of an access member of the data storage system according to the present invention. Access member 300 may be arranged to detect an unauthorized attempt to access the data by the unauthorized user. Such an unauthorized attempt may include receiving an invalid login signal such as an invalid password or at least one characteristics of the unauthorized user entered by the unauthorized user, unauthorized movement of storage member 210, unauthorized uncoupling of storage member 210 from an article to which access member 300 is coupled, unauthorized disassembly of storage member 210, and the like.

Particular examples of the unauthorized attempts may include, but not necessarily limited to, receiving the invalid login signals for a pre-determined number of times, receiving the invalid login signal for a pre-determined period, receiving no valid login signals for a pre-selected period, and the like. As discussed above, the invalid login signals relating to the characteristics of the unauthorized user may include visual or audio signals representing, e.g., finger prints, facial patterns, distribution patterns of blood vessels in various anatomical parts including retinas, eyes, hands, and arms, voices, breadths, various physiological characteristics, and the like. Other types of login signals may also be used separately or in conjunction with the foregoing login signals. For example, the user may wear a signaling device transmitting secondary login signals through a wire or wirelessly. Therefore, when the user wears such signaling devices within a pre-selected distance and/or in the proximity of access member 300, access member 300 may receive both the primary login signal and the secondary signal and may assess validity of the user.

Access member 300 may be arranged to sense or monitor any movement of storage member 210 with respect to stationary objects such as the ground and/or to other parts of data storage system 200 and computer 100 such as CPU 110, input-output unit 130, process member 230, guard member 400, and so on. For this purpose, access member 300 may include at least one conventional motion sensor. Alternatively, access member 300 may be arranged to sense or monitor mechanical, physical, electrical, optical, and/or functional uncoupling of storage member 210 from any articles to which at least a portion of access member 300 may be mechanically, physically, electrically, optically, and/or functionally coupled, respectively. Various conventional sensors may be applied to sense or monitor such uncoupling. For example, a displacement sensor and/or a force transducer may be incorporated between storage member 210 and any of the foregoing articles to monitor physical and/or mechanical uncoupling of storage member 210. Conventional voltmeters or amperometers may be incorporated between storage member 210 and such an article so as to measure electrical coupling and uncoupling therebetween. Depending upon the detailed configuration, the sensors may be arranged to assess the uncoupling as, e.g., an open circuit, a closed circuit, a change in a circuit voltage and/or current, and so on. Similarly, an optical sensor may also be disposed to construct a line of detection and arranged to monitor any object protruding across and/or crossing the line, thereby monitoring optical coupling and/or uncoupling therebetween. When storage member 210 is arranged to have at least one memory unit for storing such data and a housing for retaining at least a substantial portion of the memory unit therein, access member 300 may include any of the foregoing sensors so as to monitor a disassembly of at least a portion of the memory unit from and/or out of the housing.

Access member 300 may include at least one input receiving unit 310, at least one logic unit 320, and at least one signal generating unit 330. Input receiving unit 310 may be generally arranged to receive a login signal entered by the user through input-output unit 130 and relays the input signal to logic unit 320 which then assesses its validity, e.g., by comparing the login signal of the user with contents of a list or an array of authorized passwords, anatomical and/or physiological characteristics of the authorized users, and so on. When the login signal is assessed to be valid, logic unit 320 may allow the user to access an operating system and data stored in storage member 210. However, when the login signal is assessed to be invalid, logic unit 320 activates signal generating unit 330 which in turn generates an alarm signal and transmits such a signal to guard system 400 that will be discussed in greater detail below.

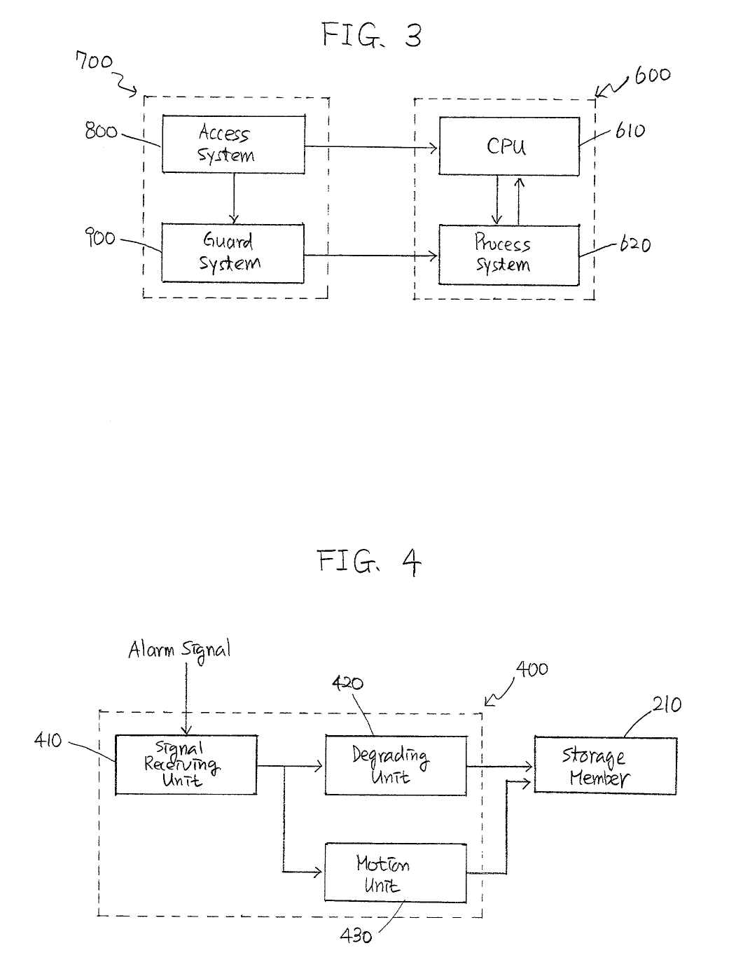

It is appreciated that detailed configuration of various members of this invention may not be material within the scope of the invention as long as such members may operate to accomplish such foregoing objectives. For example, a single input-output unit 130 of computer 100 may additionally be used as input receiving unit 310 of access member 300. This embodiment may readily be realized by incorporating suitable software into input-output unit 130. Input receiving unit 310 and logic unit 320 may be combined into a single unit. Alternatively, signal processing unit 330 may be combined with one or both of input receiving unit 310 and logic unit 320. Other functional equivalents may be also employed as long as access member 300 may be arranged to monitor an unauthorized attempt to log in to computer 100 and/or to access the data. For example, FIG. 3 denotes a schematic diagram of another exemplary data storage system with configuration different from that of FIG. 1 according to the present invention. In this embodiment, a computer 600 is represented by two functional units, such as a CPU 610 and a process system 620, both corresponding to CPU 110 and process member 130 of FIG. 1, respectively. Provided with computer 600 is a data security system 700 that includes an access system 800 and a guard system 900, each of which may be at least substantially similar or identical to access member 300 and guard member 400 of FIG. 1, respectively. Although not shown in this figure, process system 620 may include at least one storage member, data read-only member, data write-only member, data read-write member, and so on. Access system 800 may be functionally coupled to CPU 610 and/or process system 620 and arranged to monitor such unauthorized attempts to access the data stored in computer 600 and/or its storage member. Guard system 900 may also be functionally coupled to CPU 610 and/or process system 620, and may be arranged to degrade at least a portion of the data. It is also appreciated that input receiving unit 310 and/or logic unit 320 may be arranged to provide the user more than one opportunity to provide valid login signals. For example, when the user may supply invalid login signals, one of input receiving unit 310 and/or login unit 320 may allow the user to provide one or more login signals. As discussed above, detailed configuration and/or architecture of access member 300 is generally a matter of choice that largely depends upon a design selection made by one of ordinary skill in the relevant art.

FIG. 4 is a schematic diagram of an exemplary embodiment of a guard member of the data storage system according to the present invention. Guard member 400 may be operationally coupled to at least one of storage member 210 and access member 300. Upon detecting any of the foregoing unauthorized attempts by the unauthorized user or after elapsing a pre-determined period of detecting such attempts, guard member 400 may be arranged to degrade at least a portion of the data stored in storage member 210. Guard member 400 of this invention may be arranged such that a first amount of such data degraded thereby during a pre-determined period is larger than a second amount of such data processed by process member 230 during the same predetermined period. Guard member 400 may preferably be arranged not to encrypt the data and not to perform reading the data from storage member 210 and/or writing the data into storage member 210.

Exemplary guard member 400 of FIG. 4 may include at least one signal receiving unit 410, at least one degrading unit 420, and/or at least one optional motion unit 430. Signal receiving unit 410 may be arranged to receive the alarm signal that is generated by signal generating unit 330 of access member 300. The alarm signal may then activate degrading unit 420 to effect degradation of at least a portion of the data stored in storage member 210 and/or degradation of at least a portion of storage member 210 itself. In order to facilitate degradation of the data and/or storage member 210 therein, optional motion unit 430 may be arranged to displace, move, translate or rotate at least a portion of storage member 210 (or degrading unit 420) with respect to at least a portion of degrading unit 420 (or storage member 210) before, during, and/or after such degradation. It is appreciated that detailed configuration of the foregoing units of guard member 400 may not necessarily be material within the scope of the invention as long as guard member 400 may operate to perform the foregoing functions. For example, guard member 400 may be arranged to not include any signal receiving unit 410, while degrading unit 420 of guard member 400 may be activated directly by the alarm signal transmitted by signal generating unit 330 of access member 300. By the same token, access member 300 may be arranged not to include any signal generating unit 330, and degrading unit 420 of guard member 400 may be activated directly by logic unit 320 of access member 300.

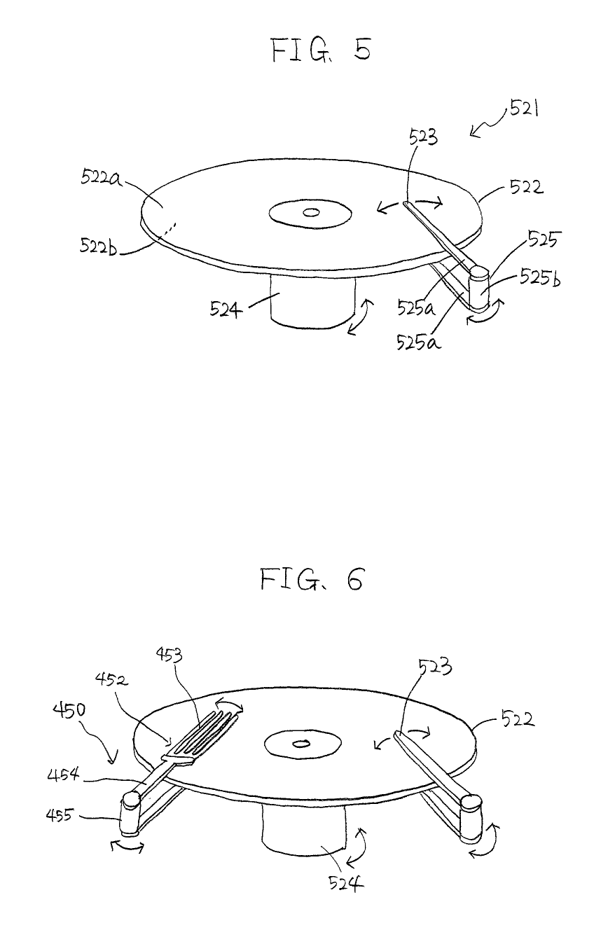

Various mechanisms may be incorporated into such degrading unit 420 for such degradations such as, e.g., magnetic degradation of the data, optical degradation of the data, chemical degradation of storage member 210 and/or data, mechanical degradation of storage member 210 and/or data, and the like. In addition, depending upon the nature of such degradation, guard member 400 may include at least one power supply unit arranged to provide guard member 400 with at least one of mechanical, electrical, and/or magnetic power enough to effect the degradation of storage member 210 and/or the data. FIGS. 6 through 8 illustrate different embodiments of degrading unit 420 in greater details. In order to juxtapose structural or configurational differences between conventional disk drive and data storage system 200 of the present invention, a typical conventional disk drive is described in FIG. 5.

FIG. 5 is a perspective view of a prior art hard disk unit according to the present invention. A hard disk unit (i.e., hard disk driver or simply referred to as hard disk) 521 includes at least one data storage device or data storage unit such as a magnetic or optical disk 522, two read/write magnetic or optical heads 523 each being disposed on a top surface 522a and a bottom surface 522b of disk 522, a disk rotator 524 arranged to rotate magnetic or optical disk 522, and a head driver 525 arranged to laterally move read/write heads 523. Magnetic or optical disk 522 typically stores the data therein by forming therealong multiple magnetic or optical bands. Read/write heads 523 may generally contain metal coils that are wound around a metal core made of, e.g., iron, and are disposed adjacent surfaces 522a, 522b of magnetic or optical disk 522. When hard disk unit 521 is to operate in the real mode, read/write heads 523 are disposed adjacent to the magnetic or optical bands formed on surfaces 522a, 522b of magnetic or optical disk 522 rotated by disk rotator 524. The magnetic or optical bands may induce electric current through the coils of read/write heads 523 that are converted into the bit-wise data. When hard disk unit 521 operates in a write mode, an electric current may be fed to the coils of read/write heads 523 according to sequences of the data to be written on magnetic or optical disk 522. The current-flowing coils generate a magnetic field therearound and magnetize one or both surfaces 522a, 522b of magnetic or optical disk 522. During such read/write operations, disk rotator 524 may rotate magnetic or optical disk 522 to facilitate the reading and writing processes. Head driver 525 is arranged to move read/write heads 523 back and forth across top and/or bottom surfaces 522a, 522b of magnetic or optical disk 522 so that read/write heads 523 can access all areas of top and/or bottom surfaces 522a, 522b of magnetic or optical disk 522 that are available for processing such data. Hard disk unit 521 shown in FIG. 5 also includes a pivot 525b and a pair of arms 525a, where arms 525a connect read/write heads 523 to pivot 525b. By properly arranging rotatable pivot 525b, arms 525a and read/write heads 523 can access different areas across magnetic or optical disk 522. Hard disk unit 521 is generally disposed in a case (not shown) to prevent collection of dust. It is noted that the conventional hard disk units having configurations different from the one shown in FIG. 5 may also be used. For example, such a disk unit may include two or more magnetic or optical disks and three or more read/write heads.

FIG. 6 is a perspective view of another exemplary embodiment of a guard member of the data storage system effecting magnetic degradation of a storage member and/or various data according to the present invention. Such a guard member 400 is generally arranged to generate magnetic field by various magnetic degrading units 420 such as, e.g., electromagnetic unit or permanent magnetic units disposed adjacent to and/or around at least one pre-selected portion of storage member 210 to effect the magnetic degradation of the data stored in the portion of storage member 210. Various degrading units 420 may be employed to generate the magnetic field that may effect such degradations.

In one embodiment, magnetic degrading unit 420 of guard member 400 may include at least one electromagnetic unit 450 arranged to generate such magnetic field upon or after access member 300 detects the unauthorized attempts to access the data. Electromagnetic unit 450 typically includes at least one head 452 having at least one electromagnet (i.e., electric magnet) 453 disposed on, over, around or adjacent at least a portion of storage member 210 such as surfaces 522a, 522b of disk 522. Upon detecting the unauthorized attempt and/or receiving the alarm signal, electric current is fed to head 452 so that electromagnet 453 generates the magnetic field enough to degrade, deform, change, erase or alter the coding patterns of the magnetic bands formed on surfaces 522a, 522b of disk 522. Head 452 is, therefore, arranged to be disposed within a pre-selected distance from at least a portion of storage member 210 to ensure the foregoing magnetic degradation. Electromagnet 453 may also be attached to auxiliary arms 454 of a rotatable hinge 455 so that electromagnet 453 may be moved across disk 522 and degrade at least more than a negligible portion of the data stored in disk 522 of storage member 210. Although not shown in FIG. 6, electromagnet 453 may be disposed adjacent to a rotating shaft of disk rotator 524 either fixedly or rotatably. In the alternatively, electromagnet 453 may also be attached to an interior of a case (not shown) and/or arms 525a, 525b of read/write head 523. In addition, electromagnet 453 may be arranged to form a coil or core arranged to wrap around at least a portion of storage member 210 and to subject such a portion to the magnetic field generated thereby.

In another embodiment, read/write head 523 of hard disk unit 521 may be recruited and used to magnetically degrade the data stored on surfaces 522a, 522b of disk 522. For example, degrading unit 420 may be arranged to manipulate read/write head 523 to change the magnetic coding patterns of the magnetic bands formed on such surfaces 522a, 522b. Accordingly, all of the magnetic bands may be reset to bit data corresponding to “0's” or “1's” which approximates the initialization process of disk 522. Alternatively, read/write head 523 may be arranged to randomly or systematically alter the coding patterns of the magnetic patterns on such surfaces 522a, 522b of disk 522. In particular, when read/write head 523 may be arranged to perform a systematic degradation, degrading unit 420 may manipulate read/write head 523 to change the coding patterns of the magnetic bands according to a pre-determined pattern or sequence of degradation. For example, read/write head 523 may be arranged to reverse the direction of, e.g., every third magnetic band. Such an embodiment offers the benefit of providing the authorized user with the capability of reconstructing the degraded data such that the degraded portion of disk 522 may be reverted back into its original coding patterns. In such an embodiment, the portion of storage member 210 and/or read-only memory units storing such predetermined pattern or sequence may also be degraded as well so as to prevent the unauthorized user from performing the reconstruction of the degraded data.

When degrading unit 420 has the foregoing embodiments, electromagnetic unit 450 may be arranged to generate the magnetic field therearound only upon needed. For example, before access member 300 detects any unauthorized attempts, electric current is not fed through electromagnet 453 so that no magnetic field is formed at all. Only upon detecting such attempts, electromagnet 453 can generate such magnetic field. Accordingly, such electromagnetic unit 450 may be disposed in close proximity with storage member 210 and/or surfaces 522a, 522b of disk 522 without jeopardizing the integrity of the data stored therein.

It is appreciated that the foregoing magnetic degrading unit 420 of guard member 400 such as electromagnetic unit 450 may include at least one power supply unit that is arranged to supply guard member 400 with enough electric power to activate electromagnet 453 thereof. Such a power supply unit may preferably be disposed inside storage and/or guard members 210, 400 and be preferentially used as an internal power supply unit which may operate independently of any external power supply unit disposed outside of storage and/or guard members 210, 400. Thus, even when the unauthorized user disconnects the external power supply thereto, guard member 400 may activate degrading unit 420 and initiate the foregoing degradations of the data stored in storage member 210. It is also noted that detailed configuration of electromagnet 453 is generally a matter of choice for a person skilled in the relevant art.

FIG. 7 is a perspective view of yet another exemplary embodiment of a guard member of the data storage system effecting another magnetic degradation of a storage member and/or various data according to the present invention, where guard member 400 is arranged to include, as its degrading unit 420, at least one permanent magnetic unit 460 rather than electromagnetic unit 450 of FIG. 6. It is noted that permanent magnetic unit 460 generally includes at least one magnetic head 462 having at least one permanent magnet 463 therein, thereon, and/or at other pre-selected locations. Because permanent magnet 463 generates magnetic field therearound constantly, guard member 400 may be preferably arranged to dispose permanent magnetic unit 460 farther than a pre-selected distance from at least a portion of storage member 210 and/or to provide at least one magnetic shield between such a permanent magnet 463 and the portion of storage member 210. Various embodiments may be used to accomplish such objectives.

In one exemplary embodiment, guard member 400 includes at least one actuator unit 464 that may be arranged to dispose permanent magnetic unit 460 in its first position that is farther than the pre-selected distance from the portion of storage member 210 before detection of any unauthorized attempts such that the magnetic field from permanent magnet 463 does not affect integrity of the data stored in storage member 210 and/or operation of other members of data storage system 200 of this invention. Actuator unit 464 may then be arranged to move permanent magnet unit 460 to its second position that is within the pre-selected distance from the portion of storage member 210 upon or after detecting such attempt so that degradation can be effected. Alternatively, guard member 400 may include at least one shield unit (not shown in the figure) capable of insulating at least a substantial portion of magnetic fluxes emanating from permanent magnet 463 from propagating or reaching the portion of storage member 210. Actuator unit 464 may be arranged to interveningly place the shield unit in its first position that is between permanent magnet 463 and the portion of storage member 210 before detection of the unauthorized attempts to access the data stored in storage member 210. Upon detecting such attempts, however, actuator unit 464 may be arranged to move the shield unit toward its second position away from its first intervening position, thereby allowing the magnetic fluxes that emanate from permanent magnet 463 to reach the portion of storage member 210 and to degrade the data stored therein. Permanent magnetic head 462 and its permanent magnet 463 may have various configurations such as, e.g., a round rod, a peg, a stick, a horse-shoe, and a coil, as long as they can cover the portion of storage member 210 to be degraded.

In another embodiment, permanent magnetic head 462 may be arranged to include a chamber (not shown in the figure) including multiple articles or particles that are ferromagnetic, ferrimagnetic, paramagnetic, and the like. The chamber may preferably be arranged to retain the magnetic particles therein before detecting any unauthorized attempts and then to disperse such particles onto at least a portion of storage member 210 upon or after detecting such attempts, thereby degrading the desired portion of storage member 210. Guard member 400 may include the foregoing shield unit insulating the portion of storage member 210 from being affected by the magnetic fluxes emanating from the magnetic particles. Alternatively, the chamber may be made of material at least partially insulating such magnetic fluxes from such particles. At least one actuator unit similar to those of FIGS. 5 and 6 may also be arranged to move the chamber from a first position farther than the pre-selected distance from the portion of storage member 210 to a second position that is within the pre-selected distance.

In any of the above magnetic embodiments, at least a portion of storage member 210 may be arranged to move, translate or rotate during the degradation of the portion of storage member 210 or the data stored therein. Such movement, translation, and rotation generally facilitate distribution of the magnetic fluxes onto wider portions of storage member 210 and yield more efficient degradation thereof. For example, various magnetic heads 452, 462 may be attached to auxiliary arms 457, 467 which extend toward rotatable hinges 458, 468 such that such heads 452, 462 may be moved across disk 422 and degrades a substantial portion of the data stored therein. Although not shown in any of the figures, magnetic heads 452, 462 may also be disposed in other locations such as, e.g., adjacent to rotating shafts of disk rotator 524. Magnetic heads 452, 462 may be able to rotate by a centrifugal force generated by rotating disk 522. When multiple disks 522 are stacked along rotating shaft 524, foregoing magnetic heads 452, 462 may be used in any number, any arrangement or any combination. The foregoing permanent magnetic guard member 400 may also include at least one power supply unit to operate, e.g., the actuator units, applicator units, and the like.

Although not shown in the figures, guard member 400 may be arranged to irradiate amplified light rays to effect degradation of at least a portion of storage member 210 and/or data stored therein. This embodiment may be preferred to prevent the unauthorized attempts to access the data stored in various optical media such as, e.g., optical compact disks, optical digital video disks, and so on. In such an embodiment, guard member 400 may include at least one light source capable of emitting such light rays. A typical example of such amplified light rays is the laser which can be irradiated by various conventional laser tubes or bulbs. Such a guard system 400 may preferably include at least one power supply unit capable of supplying electric power enough to operate such laser equipment and to irradiate such amplified light rays onto the portion of storage member 210. Guard system 400 may include various optical elements arranged to guide such light rays therealong or therethrough, examples of which may include, but not necessarily limited to, mirrors, lenses, prisms, wave-guides, optical fibers, optical connectors, and the like. In particular, various optical elements may be applied so that the light rays from a limited number of light sources may be reflected to multiple locations on storage member 210. In addition, at least one reflecting object including multiple pieces of mirrors disposed at different angles may be moved, translated or rotated to reflect such amplified light rays onto wider portions of storage member 210.

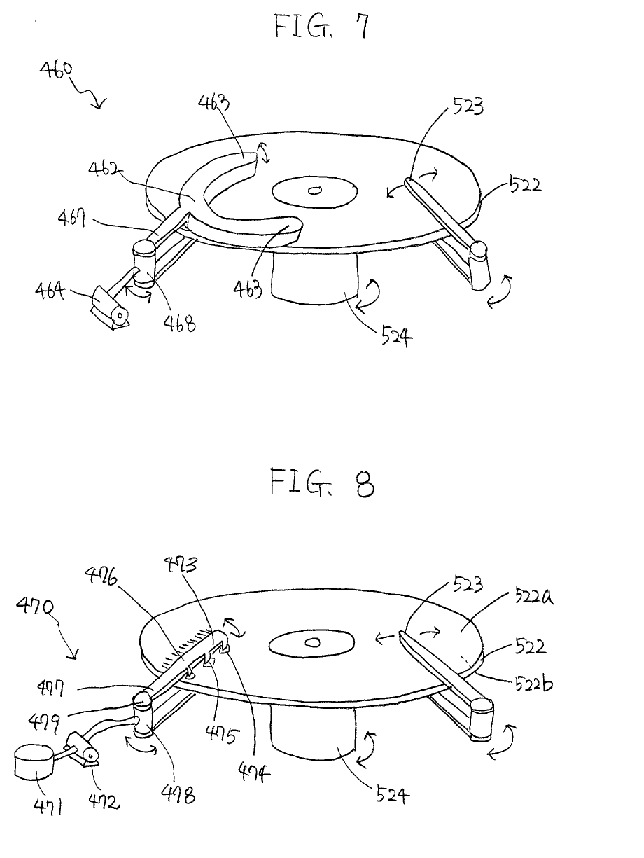

FIG. 8 is a perspective view of yet another exemplary embodiment of a guard member of the data storage system effecting chemical degradation of a storage member and/or data according to the present invention. Such a guard member 400 may be typically arranged to contact at least a portion of storage member 210 with at least one chemical agent to effect such degradation. In general, such a portion of storage member 210 contacted by the chemical agent at least partially corresponds to the portion of storage member 210 including at least partially degraded data.

Such chemical agents may generally have properties of degrading at least a portion of storage member 210 and/or at least a portion of the magnetic or optical bands representing the data. Typical examples of such chemical agents may include, but not necessarily limited to, organic and inorganic solvents capable of chemically degrading various substances used to form storage member 210 such as, e.g., silicon, aluminum, germanium, zirconium, and various semiconductive substances including semiconductive polymers. More particularly, such chemical agents may cause chemical change such as, e.g., oxidation, reduction, dissolution, corrosion, adhesion, vulcanization, crystallization, changes in crystalline phases, polymerization, fusion, magnetization, para-magnetization, and so on. Typical examples of such chemical agents also include various fluoride, chloride, and/or bromide compounds. Various etchants conventionally used in semiconductor fabrication may also be used as the chemical agents. Selection of the chemical substances may depend upon the characteristics of storage member 210 and/or necessary extent or depth of degradation thereof. Such chemical agents may also be used in any form or phase such as liquid, gel, foam, gas, vapor, aerosol, particulate, solid, particles, and/or mixtures thereof. Selecting appropriate chemical agents and/or phases thereof is generally a matter of choice of one with ordinary skill in the art.

Such chemical agents may be delivered to storage member 210 by numerous mechanisms. As shown in FIG. 8, guard number 400 includes at least one chamber 471 and at least one actuator unit 472, where chamber 471 is arranged to store the chemical agent therein and actuator unit 472 is arranged to displace or move the chemical agent out of chamber 471 toward a pre-select portion or portions of storage member 210. Before access member 300 detects the unauthorized attempt by the unauthorized user, the chemical agent is stored in chamber 471 and, therefore, does not contact any portion of storage member 210. Although not shown in the figure, guard member 400 may include at least one conduit unit arranged to guide the chemical agent to or toward at least one pre-selected location inside storage member 210, e.g., over pre-selected selected locations of magnetic or optical disk 522 such as on surfaces 522a, 522b thereof.

Guard member 400 may include at least one applicator unit 473 disposed in such pre-selected locations inside storage member 210, arranged to receive the chemical agent dispensed by actuator unit 472 from chamber 472, and dispense the chemical agent accordingly. Applicator unit 473 may be arranged to be void of any chemical agent before access member 300 activates actuator unit 472 which then primes the chemical agent from chamber 471 and fills an inside of applicator unit 473. In the alternative, guard member 400 may include at least one cover unit 474 arranged to move between a covering position and a non-covering position. Before access member 300 detects an unauthorized attempt by the unauthorized user, applicator unit 473 may be arranged to contain the chemical agent therein and may prevent the chemical agent from contacting storage unit 210 by cover unit 474 that is interveningly disposed in its covering position, i.e., between at least one tip 475 of applicator unit 473 and the pre-selected locations in storage member 210. Upon detecting the unauthorized attempt to access the data, access member 300 may activate actuator unit 472 which may then move cover unit 474 to the non-covering position thereof such as, e.g., away from tip 475 of applicator unit 473, thereby effecting a chemical contact between the chemical agent and such pre-selected portions of storage member 210.

Guard member may also include another applicator unit 476 that resembles a wick wetted by the chemical agent. Such applicator unit 476 may be generally disposed away from the pre-selected locations of storage member 210 before access member 300 detects any unauthorized attempt by the unauthorized user. Upon detecting the unauthorized attempt to access the data, access member 300 may activate actuator unit 472 to move applicator unit 476 to such pre-selected portions of storage member 210 to effect such a chemical contact therebetween. Although not shown in the figure, such applicator unit 476 may be disposed inside a housing to prevent accidental chemical contact between the chemical agent and storage member 210.

Detailed delivery mode of the foregoing chemical agent may vary, depending upon the phase characteristics and/or dynamic or kinematic viscosity thereof. For example, liquid chemical agents may be sprayed or dropped onto storage member 210. Gaseous chemical agents may be arranged to fill a confined space in which at least a portion of storage member 210 such as its magnetic or optical disk 522 is sealingly disposed. Gel chemical agents may preferably be delivered by any of the above applicator units 473, 476, solid chemical agents may be delivered in the form of aerosols, particulates, and the like. The foregoing chemical agents may also be delivered mixed with various carriers. For example, magnetic metal powder mixed with an optional adhesive may be dispensed or sprayed onto surfaces 522a, 522b of disk 522, thereby degrading the coding pattern of the magnetic bands thereof. In addition, the chemical agent which can form a non-peelable bond with surfaces 522a, 522b of disk 522 may also be delivered to storage member 210. Any attempt to remove the bond will destroy the magnetic or optical encoding on surfaces 522a, 522b of disk 522.

As discussed above, at least a portion of storage member 210 may be arranged to translate or rotate during the degradation thereof. Such translation or rotation generally facilitates distribution of the chemical agent onto a wider portion of storage member 210. For example, chamber 471 may be attached to auxiliary arms 477 which extend toward a rotatable hinge 478 so that chamber 471 may be moved across disk 422 and degrades a substantial portion of the data stored therein. Although not shown in the figure, chamber 471 may also be disposed adjacent a rotating shaft 479 of disk rotator 524. The chemical agent dispensed from chamber 471 toward rotating shaft 479 may be dispersed across surfaces 522a, 522b of disk 522 via the centrifugal force generated by rotating disk 522 and, therefore, the distribution of such a chemical agent may be facilitated across almost an entire region of disk 522. The foregoing conduit unit (not shown in the figure) may be provided around or inside rotating shaft 479 such that the chemical agent may be delivered therethrough. When multiple disks 522 are stacked along rotating shaft 524, such an embodiment may prove beneficial in delivering the chemical agent to each disk 522. Alternatively, chamber 471 may be attached to an interior of a case (not shown in the figure) or to arms 525a, 525b of read/write heads 523 to facilitate direct delivery of the chemical agent onto pre-selected locations or trajectories on surfaces 522a, 522b of disk 522. When a toxic chemical agent is used, guard member 400 may include at least one auxiliary chamber containing a neutralizer for such an agent. In such an embodiment, the neutralizer may be delivered to disk 422 and removes any toxicity of remaining toxic substances after the degradation of the data or storage member 210 is completed.

The foregoing chemical guard member 400 may also include at least one power supply unit to operate, e.g., actuator unit 472, applicator unit 473, 476, and the like. Such power supply unit may provide electric power to various units of guard member 400 in such an amount enough to effect the chemical degradation. It is appreciated that guard member 400 may be provided with self-operating applicator units as well. For example, chamber 471 may be pressurized to include gaseous, vapor or liquid chemical agent at a pressure which is higher than the atmospheric pressure. Upon detecting an unauthorized attempt by an unauthorized user, guard member 400 may be arranged to open a valve of chamber 471 and/or to puncture chamber 471 to deliver the chemical agent to storage member 210.

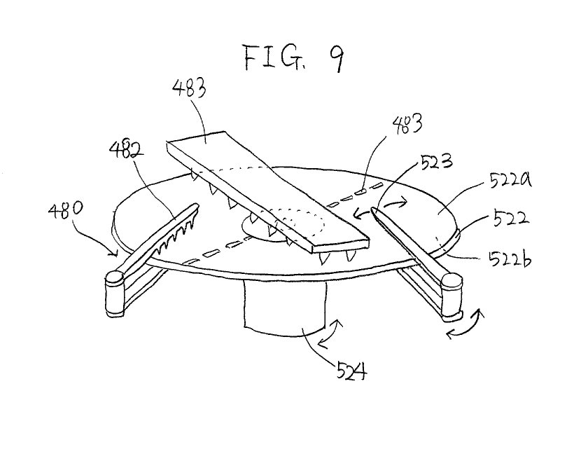

FIG. 9 is a perspective view of yet another exemplary embodiment of a guard member of the data storage system effecting mechanical degradation of a storage member and/or data according to the present invention. Such a mechanical guard member 400 is generally arranged to mechanically damage at least a portion of the storage member to effect such degradation by causing such as, e.g., deformation of the portion of storage member 210 while maintaining a structural and/or mechanical integrity of storage member 210, disintegration of at least the portion thereof, scraping or grinding of at least the portion thereof, and so on. Guard member 400 may include at least one mechanical unit 480 with at least one mechanical head 482 and/or at least one external applicator unit 483.

In one embodiment, guard number 400 may be arranged to cause mechanical deformation of the portion of storage member 210 while maintaining such an integrity of the storage member. Such deformation may be a bending and/or twisting of storage member 210 that will prevent such storage member 210 from being operated by conventional disk drivers. In order to effect such deformations, guard member 400 or, more particularly, mechanical and/or applicator units 482, 483 are arranged to apply force across a thickness of disk 522 of storage member 210 to push, compress, pull, bend, twist, elongate, squeeze, and/or punch such a portion of storage member 210. Guard member 400 may also be arranged to apply mechanical force by, e.g., an electric motor or a torque generator. Alternatively, guard member 400 may be fabricated so that force applied by the unauthorized user in uncoupling of =storage member 210 and/or disassembly thereof may cause at least one internal structure of storage member 210 to generate such deforming force. For example, dislocation of such an internal structure may be arranged to release an elastic article in its stressed state to return to its unstressed state, while generating such force.

In another embodiment, guard member 400 may also be arranged to cause disintegration or breakage of at least the portion of the storage member into multiple segments. Such a guard member 400 may generally be arranged to be at least substantially similar to or identical to that of the above embodiment, with only one exception that the amplitude of the mechanical force should be at least greater than that of the above embodiment to effect such disintegration or breakage. In addition, to facilitate such disintegration, storage member 210 may be provided with at least one impression 483 such as a protrusion and a depression along which guard member 400 may cause the disintegration of the portion of storage member 210. Impressions 483 may be, e.g., linear, curved, circular, elliptical, and/or concentric, and may also be two- and/or three-dimensional depending upon preferred patterns of the disintegration. When such impressions 483 are provided on surfaces 522a, 522b of disk 522, they may obstruct normal reading and writing operations of the data. Accordingly, such impressions 483 may preferably be provided between such surfaces 522a, 522b of disk 522.

In yet another embodiment, guard member 400 may also be arranged to grind, scrape or sand off at least the portion of storage member 210. Storage member 210 may include at least one surface portion to store the data therein and at least one core portion arranged to support the surface portion. In general, the portion of storage member 210 ground, scraped or sanded off by such a guard number may at least partially correspond to the portion of storage member 210 degraded by guard member 400.

At least a portion of storage member 210 such as disk 522 may be arranged to move, translate or rotate with respect to guard member 400 during the degradation of storage member 210 or during that of the data stored in storage member 210. Alternatively, at least a portion of guard member 400 may also be arranged to move, translate, and/or rotate with respect to storage member 210 during the degradation of such a storage member 210 and/or such data stored therein. Guard member 400 may also include at least one power supply unit arranged to supply guard member 400 with electric and/or mechanical power to cause mechanical damage on the portion of storage member 210.

Although the foregoing embodiments of the data storage systems and methods therefor are directed to protecting data stored in a hard disk or a hard disk unit, they are intended to illustrate and not limit the scope of the invention. Therefore, such embodiments may be modified within the scope of the present invention.

It is appreciated that the guard system may include a control software capable of maintaining proper operation thereof during the degradation of the storage member and data stored therein. The control software may also be arranged to maintain normal electrical and mechanical operation of the other parts of the computer, e.g., a hard disk, a read/write head, a process member, and so on. Since the degradation process will sooner than later disrupt an operating system of the computer, the hard disk may stop spinning and/or the read/write head may cease to move. As described above, when the degrading unit is disposed at the rotating shaft of the hard disk, when the operation of the degrading unit is at least partially dependent on the movement of the hard disk and/or read/write head or when the source code for operation of the degrading unit is encoded and/or stored in the hard disk, such a degrading unit may also cease to operate as soon as the operating system of the computer starts to malfunction. It is, therefore, preferred that the guard system and its degrading unit be arranged such that they can operate independently of the status of the other parts of the computer. One exemplary way of accomplishing this embodiment may be to provide an independent control software and an optional power supply unit therefor. Accordingly, even when a substantial portion of the operating system of the computer is degraded, such a control software may operate the degrading unit while spinning of the hard disk and/or laterally moving the read/write heads, thereby increasing efficiency of such degradation.

In addition, the guard member may also be provided with another control software capable of displaying benign images on a display device coupled to the computer. For example, when the guard member receives the alarm signal from the signal generating unit, the guard member may activate the control software such that the display device displays camouflage images thereon. Examples of such images may include, but not limited to, initial booting screens for Windows OS and/or McIntosh OS, screens displaying waiting messages or error messages, fake system windows, and the like. In the alternative, the display device may display other screens such as, e.g., indicating that the computer is to be accessed on a stand-alone mode due to a failure to provide valid login signals. These images will allude the unauthorized intruder into believing that the computer is booting up and will not alert such an intruder to take any further action and will allow the guard system to more likely to achieve its objectives while preventing the intruder from taking anti-protective or evasive action on his or her own

It is also appreciated that the guard system may include multiple degrading units operating on an identical mechanism or on different mechanisms to facilitate effective degradation of the storage member and the data stored therein. For example, the guard system may include not only a chemical degrading unit but also a magnetic degrading unit therein. By incorporating multiple degrading units, the time required for effective degradation may be drastically reduced. In addition, a single power supply unit may be able to power multiple degrading units.

In addition, personal and/or main-frame computers including hard disks (i.e., hard disk units with hard disk drivers and magnetic or optical disks) and various disk drivers used for floppy disks, compact disks, and/or digital video disks may be arranged to include at least some of the foregoing aspects and embodiments of the present invention. For example, the computer may be arranged to include at least one of the foregoing storage members, at least one of the foregoing process members, at least one of the foregoing access members, and at least one of the foregoing guard members such that at least a portion of the storage member and/or the data stored therein may be degraded upon or after a pre-selected period of detecting the unauthorized attempt. Another example is a data process system such as the foregoing disk drivers which is arranged to include at least one receiver member arranged to receive the data storage device therein, at least one of the foregoing process members, and at least one of the foregoing guard members that is operationally coupled to the receiver member and arranged to effect degradation of at least a portion of the data storage device and/or degradation of at least a portion of the data stored in the data storage device. These disk drivers are preferably arranged to include necessary members and units of the present invention such that they can operate without the aid of the CPU of a computer. In another example, various data storage device such as, e.g., floppy disks, compact disks, ZIP disks, and digital video disks may be provided to prevent an unauthorized user from accessing data stored therein. Such a data storage device typically includes at least one of the foregoing storage units, at least one of the foregoing guard units, at least one of the foregoing power supply units, and a housing arranged to retain at least portions of the guard unit, power supply unit, and/or storage unit therein. Furthermore, various aspects and embodiments of the present invention may also be applied to microchips used as memory devices and to microprocessors used to process data and algorithms. Similar to the foregoing data storage devices, such chips may preferably include at least one of the foregoing guard units and at least one of the foregoing power supply unit to effect similar degradation of at least a portion of a semiconductor array and/or circuits therein.

Unless otherwise specified, different members, elements, units, and/or parts of such tracking systems are not generally drawn to scales or proportion for ease of illustration. In addition, various members, elements, units, and parts of such tracking systems designated by the same numerals may generally represent the same, similar or functionally equivalent members, elements, units, and parts thereof.

It is to be understood that, while the present invention has been described in conjunction with the detailed description thereof, the foregoing description is intended to illustrate and not to limit the scope of the present invention. Other aspects, advantages, and modifications are within the scope of the following claims.

What is claimed is:

1. A data storage system for allowing an authorized user to process data stored therein and for preventing an unauthorized user from accessing said data, said system comprising:
at least one storage member configured to store said data therein;
at least one process member operationally coupled to said storage member and configured to process said data stored in said storage member; and
at least one guard member operationally coupled to said storage member and configured to effect at least one of degradation of at least a portion of said storage member and degradation of at least a portion of said data stored in said storage member.

2. The system of claim 1, wherein said storage member includes at least one of a magnetic unit configured to use magnetic characteristics to store said data therein and an optical unit configured to use optical characteristics to store said data therein.

3. The system of claim 1, wherein said process member includes at least one of a magnetic head and an optical head, each of said heads configured to perform processing of at least a portion of said data.

4. The system of claim 1 further comprising at least one access member configured to perform detection of at least one unauthorized attempt to access said data by said unauthorized user.

5. The system of claim 4, wherein said unauthorized attempt includes at least one of receiving an invalid login signal by said unauthorized user, movement of said storage member, uncoupling of said storage member from an article coupled thereto, and disassembly of said storage member.

6. The system of claim 5, wherein said receiving said invalid login signal includes at least one of receiving said invalid login signal for a pre-determined number of times and receiving said invalid login signal for a pre-determined period.

7. The system of claim 5, wherein said movement of said storage member is with respect to at least one of ground, said process member, said guard member, and said system.

8. The system of claim 5, wherein said uncoupling of said storage member from said article is at least one of electrical, optical, and mechanical.
said uncoupling of said storage member from said article.

9. The system of claim 5, wherein said storage member includes at least one memory unit and a housing, wherein said memory unit is configured to store said data at least one of magnetically and optically, wherein said housing is configured to retain at least a substantial portion of said memory unit therein, and wherein said disassembly of said storage member is to expose at least a portion of said memory unit out of said housing.

10. The system of claim 5, wherein said guard member is operationally coupled with said access member and configured to effect said degradation at least one of upon and after said detection of said unauthorized attempt.

11. The system of claim 10, wherein said guard number is configured to generate magnetic field around at least a portion of said storage member to effect said degradation.

12. The system of claim 10, wherein said guard number is configured to irradiate amplified light rays to effect said degradation.

13. The system of claim 10, wherein said guard number is configured to contact at least a portion of said storage member with at least one chemical agent to effect said degradation.

14. The system of claim 10, wherein said guard number is configured to mechanically damage at least a portion of said storage member to effect said degradation.

15. The system of claim 1, wherein said guard member includes at least one power supply unit configured to supply said guard member with at least one of electric power and mechanical power to effect said degradation.

16. A data process system for receiving a data storage device, for allowing an authorized user to store to said data storage device and to access data stored therein, and for preventing an unauthorized user from accessing said data, said system comprising:
at least one receiver member configured to receive said data storage device;
at least one process member operationally coupled to said receiver member and configured to process said data stored in said storage device received by said receiver member; and
at least one guard member operationally coupled to said receiver member and configured to effect at least one of degradation of at least a portion of said data storage device and degradation of at least a portion of said data stored in said data storage device.

17. A method for allowing an authorized access by an authorized user to data stored in a storage member and for preventing an unauthorized access by an unauthorized user to said data, said method comprising the steps of:
detecting an unauthorized attempt to access said data by said unauthorized user; and
degrading at least a portion of said data before said unauthorized user accesses said data.

18. The method of claim 17, said detecting step including at least one of the steps of:
receiving an invalid login signal by said unauthorized user;
sensing unauthorized movement of said storage member;
sensing uncoupling of said storage member from an article coupled thereto; and
sensing disassembly of said storage member.

19. The method of claim 17, said degrading step including none of the steps of:
encrypting at least a portion of said data; and
decrypting at least a portion of said data.

20. The method of claim 17, said degrading step including at least one of the steps of:
magnetically degrading said portion of said data;
optically degrading said portion of said data;
chemically degrading said portion of said data; and
mechanically degrading said portion of said data.
